(19) United States
(12) Patent Application Publication
(10) Pub. No.: US 2013/0071698 A1
(43) Pub. Date: Mar. 21, 2013

(54) Fuel Cell Stacks

(71) Applicants: Dinesh S. Yemul, Spokane Valley, WA (US); William A. Fuglevand, Spokane, WA (US); Lijun Bai, Spokane, WA (US); Mark W. Grimes, Spokane, WA (US); David R. Lott, Spokane, WA (US); Scott A. Spink, Spokane, WA (US)

(72) Inventors: Dinesh S. Yemul, Spokane Valley, WA (US); William A. Fuglevand, Spokane, WA (US); Lijun Bai, Spokane, WA (US); Mark W. Grimes, Spokane, WA (US); David R. Lott, Spokane, WA (US); Scott A. Spink, Spokane, WA (US)

(73) Assignee: RELION, INC., Spokane, WA (US)

(21) Appl. No.: 13/478,046

(22) Filed: May 22, 2012

Related U.S. Application Data
(60) Provisional application No. 61/535,799, filed on Sep. 16, 2011.

(51) Int. Cl. H01M 8/24; H01M 16/00

(52) U.S. Cl. 429/9; 429/458; 429/452

(57) ABSTRACT

The concepts relate to in-line shunting of fuel cells. In one case, a fuel cell stack can include multiple serially arranged cells. The multiple serially arranged cells can be compressed against one another and can be supplied by a fuel supply manifold that is integral and internal to the fuel cell stack. A power source can be electrically coupled with the fuel cell stack at a bus. A controller can be configured to shunt sub-sets of the fuel cell stack while the fuel cell stack continues to supply power to the bus.

### PRIORITY

This utility patent application claims priority from U.S. provisional patent application Ser. No. 61/535,799 filed 2011 Sep. 16, which is incorporated by reference in its entirety.

### SUMMARY

The concepts relate to in-line shunting of fuel cells. In one case, a fuel cell stack can include multiple serially arranged cells. The multiple serially arranged cells can be compressed against one another and can be supplied or connected by a fuel supply manifold that is integral to the fuel cell stack. A power source can be electrically coupled with the fuel cell stack at a bus. A controller can be configured to shunt sub-sets of the fuel cell stack while the fuel cell stack continues to supply power to the bus.

Another example can include a first set of serially electrically coupled cells compressed together to operate as a first fuel cell stack. The first set of cells can share an integral internal fuel supply manifold. This example can also include a second set of serially electrically coupled cells compressed together to operate as a second fuel cell stack. The second set of cells can share another integral internal fuel supply manifold. The first and second fuel cell stacks can be electrically coupled in parallel to one another relative to a fuel cell bus. A controller can be configured, via multiple switches, to shunt a sub-set of either of the first and second fuel cell stacks while the sub-set remains electrically connected to the fuel cell bus.

The above listed examples are intended to provide a quick reference to aid the reader and are not intended to define the scope of the concepts described herein.

### BRIEF DESCRIPTION OF THE DRAWINGS

The accompanying drawings illustrate implementations of the concepts conveyed in the present patent. Features of the illustrated implementations can be more readily understood by reference to the following description taken in conjunction with the accompanying drawings. Like reference numbers in the various drawings are used wherever feasible to indicate like elements. Further, the left-most numeral of each reference number conveys the figure and associated discussion where the reference number is first introduced.

FIG. 1 shows an example operating environment in which the in-line shunting concepts can be employed in accordance with some implementations.

FIG. 2 shows an example fuel cell stack system that is configured to employ in-line shunting in accordance with some implementations of the present concepts.

FIGS. 3-5 show details of specific components and/or aspects of the fuel cell stack system of FIG. 2 in accordance with some implementations of the present concepts.

FIGS. 6-7 show graphs of voltage profile examples that can be generated in accordance with some implementations of the present concepts.

FIG. 8 shows a graph of an example power output related to different shunting techniques that can result from some implementations of the present concepts.

FIG. 9 shows an example of an in-line shunting order that can be employed in some implementations of the present concepts.

FIG. 10 shows a flowchart of a method for accomplishing the present in-line shunting concepts in accordance with some implementations of the present concepts.

### DETAILED DESCRIPTION

### Overview

This patent relates to fuel cell stacks and enhancing electrical output of the fuel cell stacks via in-line shunting. A fuel cell stack (FC stack) can be thought of as a set of serially electrically coupled cells compressed together. The fuel cell stack can also include a fuel supply manifold, such as an internal, integral fuel supply manifold that supplies fuel from a fuel source to the cells of the fuel cell stack. Membrane electrode assemblies (MEAs) of a cell or group of cells within a fuel cell stack can benefit from occasional shunting. In the present implementations, sub-sets of the fuel cell stack can be shunted while the sub-set remains electrically connected to the fuel cell output (e.g., bus). Normal shunting uses the shunt by-pass method to shunt, which disengages the shunted cells and/or the entire stack from the bus before the shunt is performed. A major difference between in-line shunting and normal shunting is that in-line shunting is performed without taking the stack offline from the bus, and only a sub-set of the stack is shunted at any given time.

### Example Operating Environment

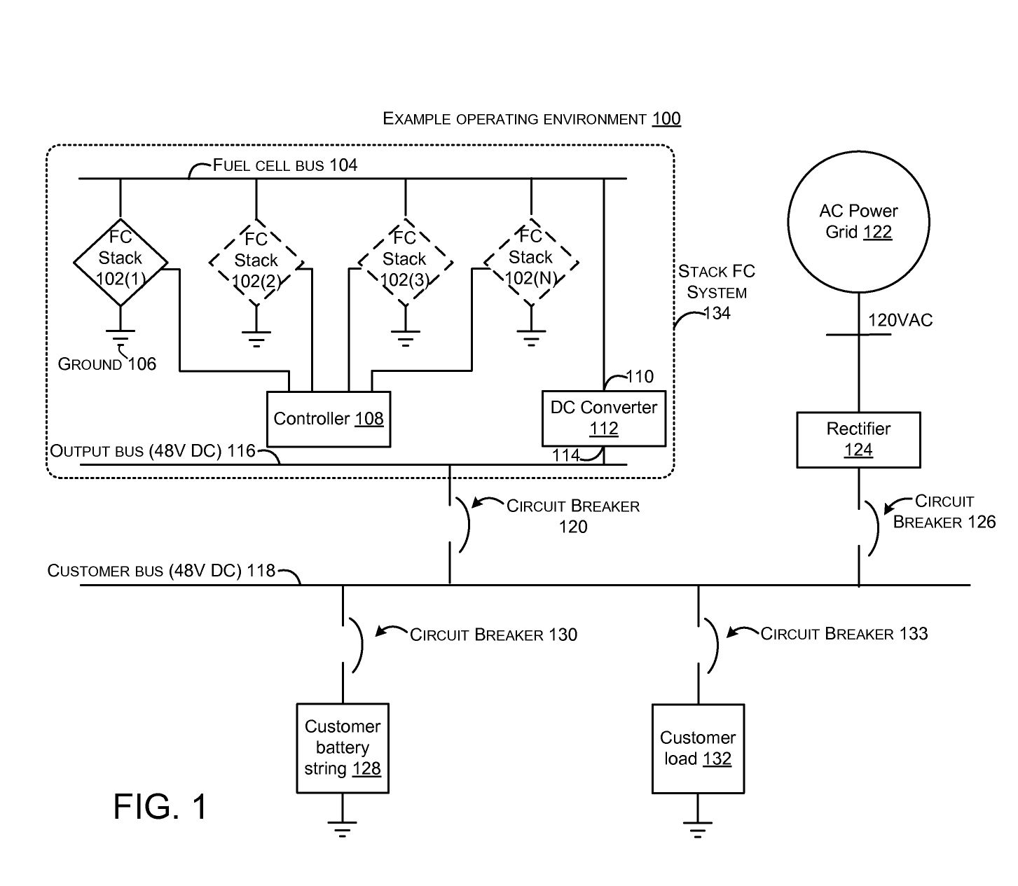

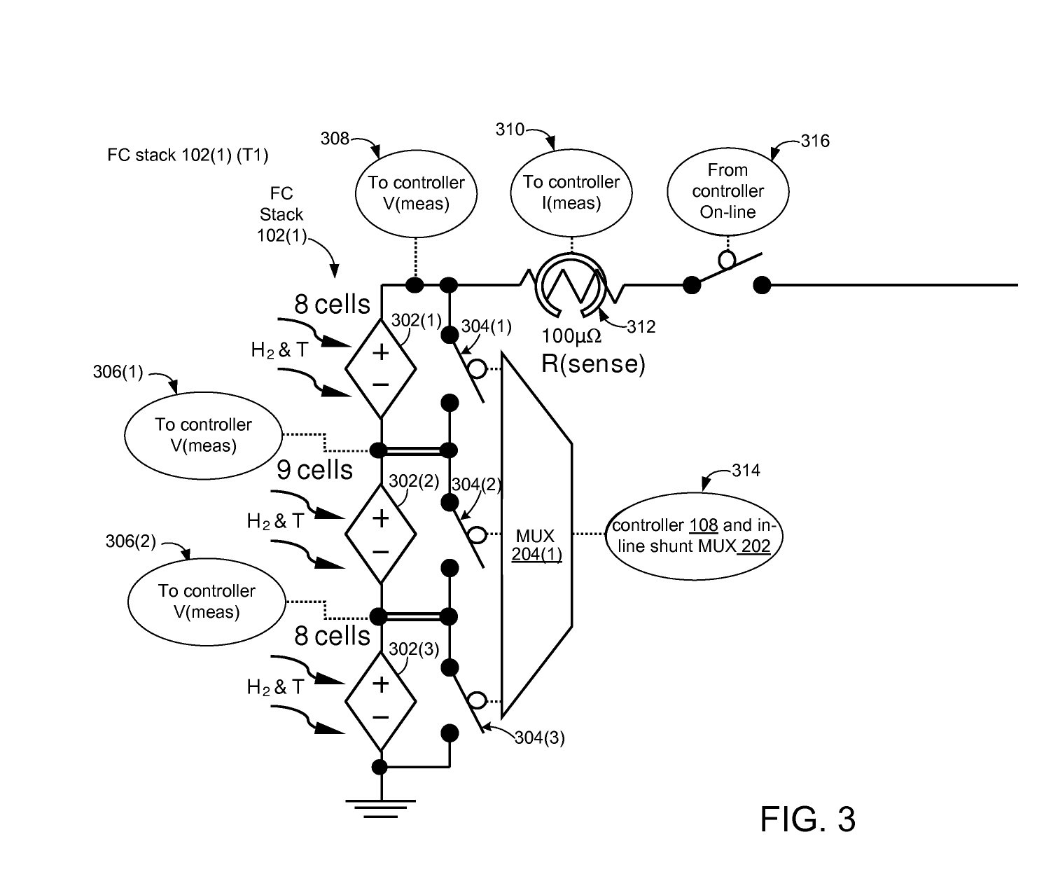

Introductory FIG. 1 shows an example operating environment 100 in which one or more fuel cell stacks 102 can be employed. In this case, four fuel cell stacks 102(1), 102(2), 102(3), and 102(N) are employed (2-N being optional and N representing that any number of fuel cell stacks can be employed). (These fuel cell stacks may alternatively be referred to as T1, T2, B3, and B4, respectively, in the discussion below). Each of the fuel cell stacks 102 can include multiple different serially arranged cells. Each of the fuel cell stacks 102 is connected to a fuel cell bus 104 and to ground 106 (not every instance of ground 106 is labeled to avoid clutter on the drawing page). The fuel cell stacks 102 are also coupled to a controller 108 via multiple switches (illustrated in FIG. 3). The controller 108 can contain a microprocessor or other processing device that is configured or configurable to control functionality related to the fuel cell stacks 102.

The fuel cell bus 104 is connected to an input side 110 of a DC power converter or “DC converter” 112. An output side 114 of the DC converter 112 is connected to an output bus 116. The output bus 116 is switchably connected to a customer bus 118 via a breaker 120. The AC power grid 122 is connected to a rectifier 124 that is then switchably connected to the customer bus 118 via another breaker 126. A customer battery string 128 is switchably connected to the customer bus 118 via another breaker 130. Finally, a customer load 132 is switchably connected to the customer bus 118 via another breaker 133.

In this case, the customer battery string 128 includes four 12 volt batteries connected in series. The DC power received from the rectifier 124 is at or slightly above 48 volts. If power is lost on the AC power grid 122, the customer battery string 128 and/or the fuel cell stacks 102 can supply power for the customer load 132. Thus, the DC converter 112 can supply 48 volts (or slightly higher) from the fuel cell stacks 102 to the output bus 116. The fuel cell stacks 102, controller 108, and DC converter 112 can be thought of as a stack fuel cell system 134. As will be described in more detail below, controller 108 can control in-line shunting of the full cell stacks 102 and as such the controller 108 can be thought of as an “in-line shunt controller”. The remainder of the document relates to operation of the fuel cell stacks 102 in this stack fuel cell system 134 or similar systems.

In one variation of example operating environment 100 that employs multiple fuel cell stacks 102, the DC converter 112 can leverage the fuel cell stacks that are not being in-line shunted (and/or other power sources, such as the customer battery string 128) to maintain voltage or current characteristics of power (such as output voltage) at the output bus 116 during the in-line shunt of a sub-set of cells of an individual fuel cell stack. As such, the controller can maintain electrical connectivity between the shunted sub-set of cells and the remaining cells (e.g., a remainder of the cells in the fuel cell stack that includes the shunted sub-set and the non-shunted fuel cell stacks). These aspects are discussed further in the description below.

### Example Stack Fuel Cell Systems

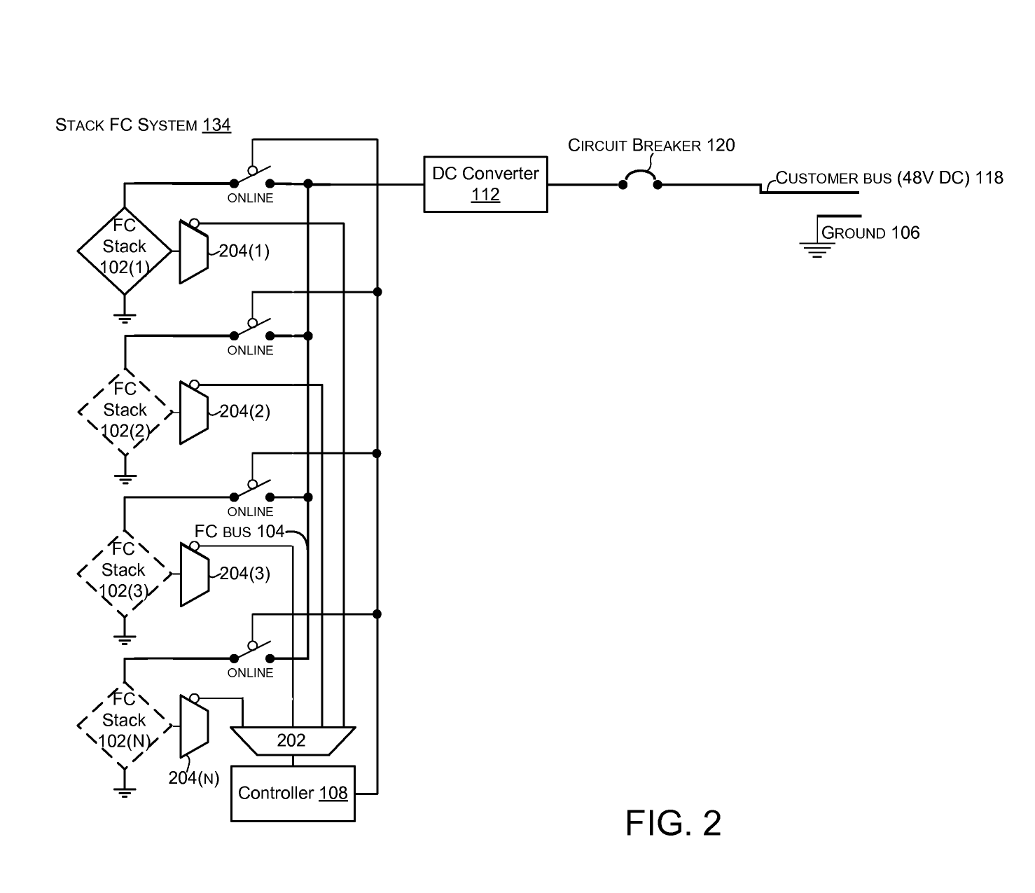

FIGS. 2-5 illustrate some elements of the stack fuel cell system 134 introduced in FIG. 1 in greater detail. Many of the elements introduced in FIG. 1 are carried over to FIGS. 2-5 and are not re-introduced for sake of brevity.

FIG. 2 shows additional details regarding fuel cell stack system 134. In this case, the fuel cell stack system includes an in-line shunt multiplexer or MUX 202 and a set of shunt switch MUXes 204. In this implementation an individual shunt switch MUX 204 is associated with each fuel cell stack 102. For instance, fuel cell stack 102(1) is connected to shunt switch MUX 204(1) and fuel cell stacks 102(2)-102(N) are connected to shunt switch MUXes 204(2)-204(N), respectively. The in-line shunt MUX 202 operates cooperatively with the controller 108 to selectively control shunting of individual fuel cell stacks 102 via the respective individual shunt switch MUXes 204(2)-204(N).

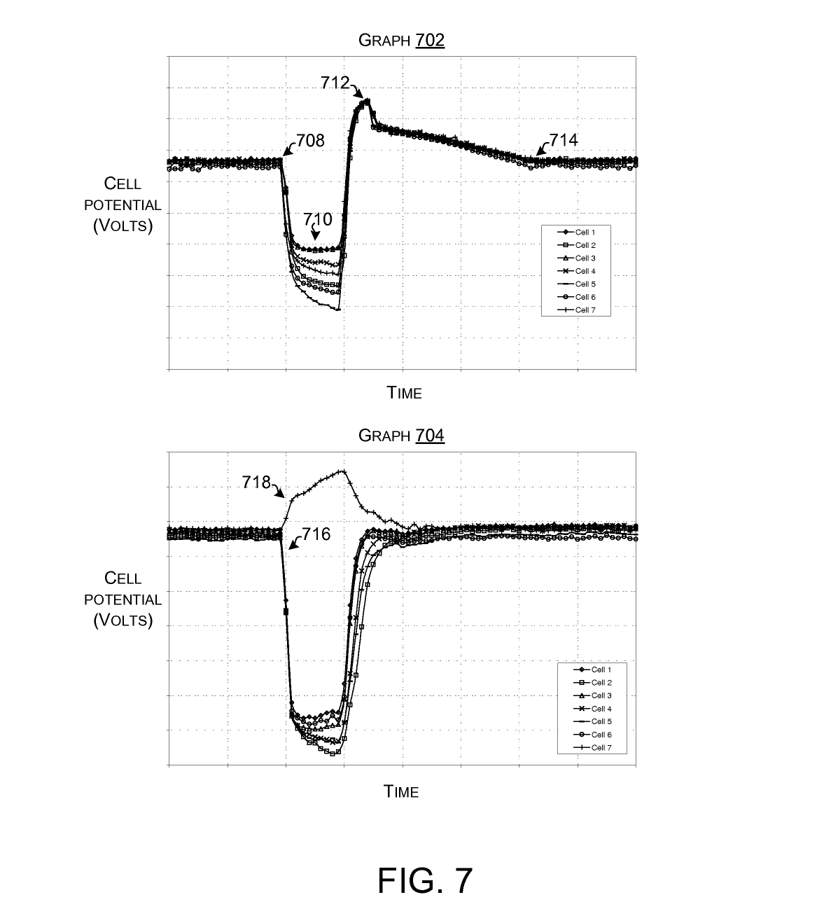

To summarize, in some implementations, the fuel cell bus 104 includes a parallel connection of multiple fuel cell stacks 102(1)-102(N) and the DC converter 112. When these devices are energized they are capable of asserting a controlling voltage on the fuel cell bus 104. Consequently, during in-line shunting of a particular stack sub-set, the other cells within the same stack will increase in voltage such that the overall stack voltage continues to match the fuel cell bus voltage. (This aspect will be described in more detail below relative to FIG. 3). The voltage increases experienced in neighboring cells during in-line shunting is evidenced in FIG. 7 (Graph 704).

FIG. 3 shows a more detailed view of fuel cell stack 102(1) and associated shunt switch MUX 204(1). In this case, the fuel cell stack 102(1) includes a set of 25 individual cells that are organized into three sub-sets: a first sub-set 302(1) of eight cells, a second sub-set 302(2) of nine cells, and a third sub-set 302(3) of eight cells. Of course, in other implementations fuel cell stacks may have less than 25 fuel cells or more than 25 fuel cells. Further, while the set of 25 individual cells are ordered into three sub-sets, other implementations can utilize other numbers of sub-sets. Finally, other implementations can utilize other numbers of cells per sub-set. For instance, a fuel cell stack that includes 25 fuel cells could be divided into sub-sets of eight, ten, and seven, or six, six, seven, and six, or five sub-sets of five, among other examples.

In this example, shunt switch MUX 204(1) is electrically coupled to first sub-set 302(1) via a switch 304(1), to second sub-set 302(2) via a switch 304(2) and to third sub-set 302(3) via a switch 304(3). The shunt switch MUX 204(1) can shunt individual sub-sets by controlling their respective switches. The function of individual sub-sets can be affected by regulating the Hydrogen (“H₂”) supplied to the sub-set as well as the temperature (“T”) of the sub-set and/or the H₂ and temperature of the stack as a whole.

In this implementation, voltage can be determined at the individual sub-sets via voltage measurements indicated at 306(1) and 306(2). These voltages can be supplied to controller 108 (FIG. 2). Voltage for the fuel cell stack 102(1) can also be measured and supplied to controller 108 as indicated at 308. Current can also be measured and supplied to the controller at 310. In this case, current is measured with a Hall effect transistor 312, but other mechanisms can be utilized in other implementations. As mentioned above in the discussion of FIG. 2, shunt switch MUX 204(1) can be controlled by in-line shunt MUX 202 and controller 108 as indicated at 314. The controller can also have the capability to switch the fuel cell stack between on-line and off-line positions as indicated at 316.

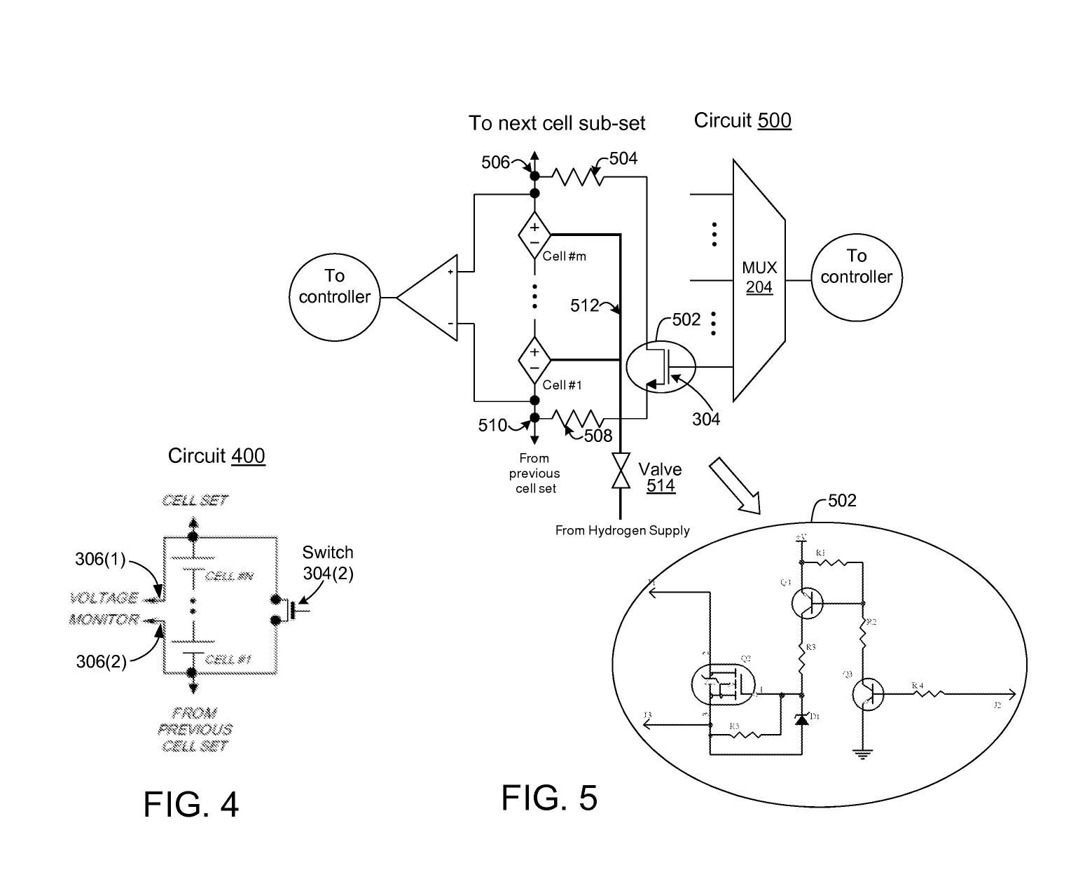

FIG. 4 shows a circuit 400 that offers further detail regarding sensing voltage across an individual sub-set of fuel cells. In this example, the sensed sub-set can be sub-set 302(2) (FIG. 3) for purposes of explanation. In this case, voltage can be sensed going into and coming out of the sub-set via switch 304(2). In this example, (as evidenced in FIG. 3) the previous sub-set is sub-set 302(3) and the next sub-set is sub-set 302(1).

FIG. 5 shows another circuit 500 that offers greater detail of an example of an in-line shunting switch configuration. Circuit 500 relates to a sub-set of cells 1-M (where M represents any positive integer), such as sub-sets 302(1)-302(3) introduced above relative to FIG. 3. The sub-sets 1-M can be positioned in a serial manner between other sub-sets designated as the previous cell sub-set and the next cell sub-set. This example is explained relative to switch 304 (FIG. 3) that can perform the in-line shunting.

A portion 502 of the circuit relating to switch 304 is enlarged for further detailed explanation provided below. The base of switch 304 is connected to shunt switch MUX 204 (FIG. 2). A resistor 504 is connected in series between the collector of the switch and the output 506 of the sub-set. Another resistor 508 is connected in series between the input 510 and the emitter of the switch 304. Circuit 500 also shows a fuel supply manifold 512 that can selectively supply hydrogen fuel to the sub-set of cells via a valve 514. Resistor values can be selected based upon input and output reference voltages of the sub-set as well as the number of cells in the sub-set and/or the stack.

As is evident from the enlarged portion 502, switch 304 can include a Zenner diode D1, an NPN transistor Q1, a FET Q2, a PNP transistor Q3, and five resistors R1-R5. The base of transistor Q3 is connected to in-line shunt MUX 202 (FIG. 2) at J1. The emitter of transistor Q3 is connected to ground. The collector of transmitter Q3 is connected to the first side of resistor R2. The second side of resistor R2 is connected to the first side of resistor R1 and to the base of transistor Q1. The second side of resistor R1 is connected to the emitter of transistor Q1. The collector of transistor Q1 is connected to the first side of resistor R3. The second side of resistor R3 is connected to the anode side of zenner diode D1, to a first side of resistor R5, to the gate of FET Q2. The cathode side of the Zenner diode D1 and the second side of resistor R5 are connected to the source of FET Q2. The drain of FET Q2 provides output J1.

Portion 502 provides one implementation of elements and arrangements of those elements or components to accomplish an in-line shunting (e.g., switching) functionality. In this case, the FET Q2, the resistor R5, and the zenner diode D1 can provide the switching functionality. Transistor Q3 and resistor R4 provide the interface to digital logic of the controller. The remaining elements can provide a hard shifter functionality. Other implementations can utilize other elements and/or achieve less or more functionality. For instance, another implementation can function with only resistor R3 and transistors Q2 and Q3. In such a configuration, resistor R3 can be connected between voltage V+ and the collector of transistor Q3. The gate of transistor Q3 can then be connected to the gate of transistor Q2. The skilled artisan should recognize still other configurations.

The above mentioned elements and combinations of elements are provided for purposes of explanation. As such, other implementations can use alternative or additional elements and/or combinations of elements to achieve the in-line shunting switching functionality and/or an associated functionality.

### Example Voltage Profiles

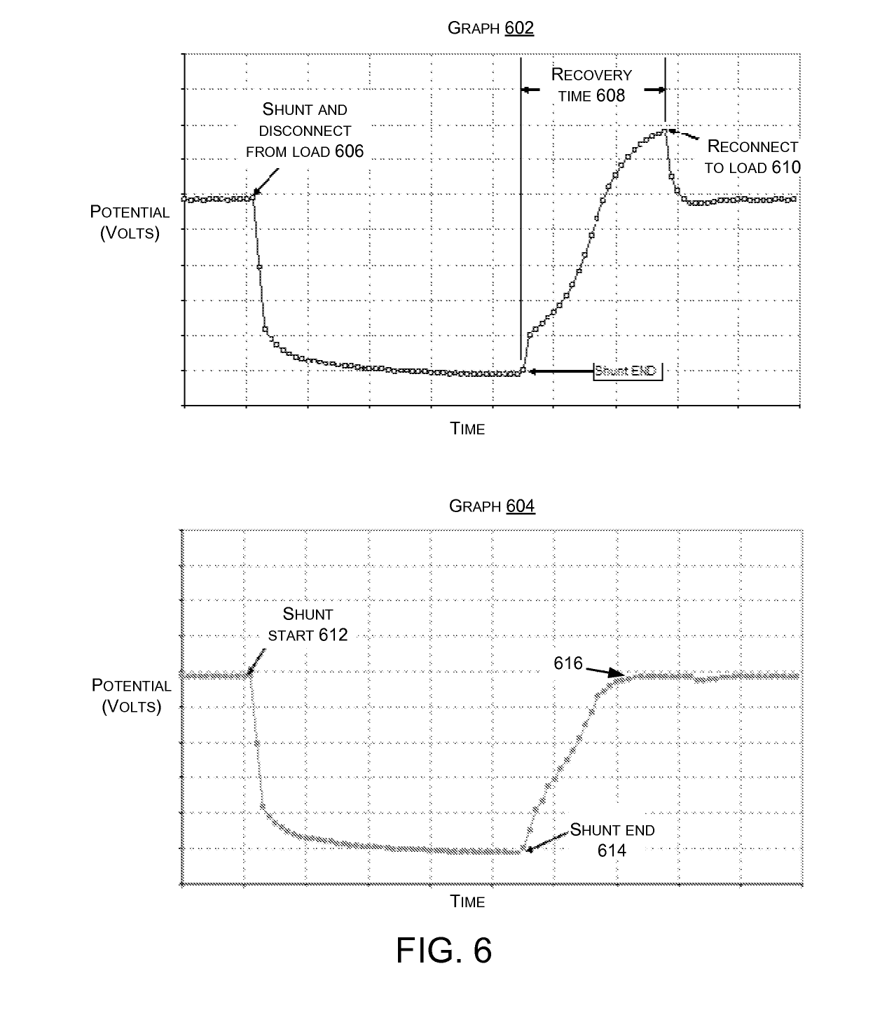

FIG. 6 shows two graphs 602 and 604 that show examples of typical cell behavior during normal and in-line shunting, respectively. Graph 602 is an example of a graph profile of a cell encountered during traditional shunting techniques of the cell and graph 604 is an example of a graph profile encountered by a cell during exemplary “in-line shunting” of the cell. The properties represented by the in-line shunting graph profile contribute to the observed performance benefits of the present in-line shunting concepts.

As seen in graph 602, the cell's operating voltage is slightly under 0.60 volts. During normal shunting, the stack is taken offline from the fuel cell bus before shunting is performed at 606, and brought back online after the predetermined recovery time 608. During the recovery time, the cell voltage increases above the operating voltage, and after recovery, when the fuel cell is brought back online at 610, the voltage decreases down to the operating voltage. In this example, the voltage during the recovery time 608 reaches almost 0.80 volts before returning to the operating voltage of about 0.60 volts after the load is reconnected at 610. Of course, the example voltages relate to one example of one type of fuel cell stack. Other implementations may produce different voltages.

Graph 604 shows the cell voltage during in-line shunting. As evidenced from graph 604, the cell is not taken off-line at anytime during the shunt, and since there is no recovery time, the cell voltage never goes above the operating voltage in this example. Specifically, in this example, the voltage drops when the shunt is started at 612. The voltage begins to rise when the shunt ends at 614 and returns to the operating voltage at (e.g., shunt recovery) 616 without overshooting the operating voltage. Note that the response to the shunt recovery 616 is similar to the unloaded example which is a positive result and allowed the cell to always stay online. As a further potential advantage in-line shunting makes the shunting process considerably simpler because all the circuitry usually needed to disconnect and reconnect stacks from the bus or cells from the stack is no longer needed. Note that graphs 602 and 604 are only examples of profiles that can be obtained through the two shunting techniques. Other implementations may produce different graph profiles.

FIG. 7 shows two graphs 702 and 704 relating to performance of a group of seven fuel cells (Cells 1-7). Graph 702 is an example of a graph profile encountered during traditional shunting techniques and graph 704 is an example of a graph profile encountered during exemplary “in-line shunting”. The properties represented by the in-line shunting graph profile contribute to the observed performance benefits of the present in-line shunting concepts.

In graph 702, in a traditional shunt all seven cells decline and then recover above operating voltage and then come back to about the original operating voltage. In this example, the operating voltage is about 0.65 volts before shunting as indicated generally at 708. During shunting all seven voltages drop below the operating voltage as indicated generally at 710. When shunting ceases, (e.g., recovery time) the voltages of the seven cells spikes past the operating voltage as indicated generally at 712 and then gradually return to the operating voltage as generally indicated at 714.

In contrast, graph 704 shows in-line shunting of cells 1-6. Stated another way, cells 1-6 can be thought of as a first sub-set of cells that are shunted while cell 7 can be thought of as a second sub-set (or part of a second sub-set) that is not being shunted. The shunted cells 1-6 decline in voltage during the in-line shunting as indicated generally at 716. In contrast, the non-shunted cell 7 increases in voltage during the in-line shunting process as indicated generally at 718. Stated another way, cell 7's voltage (and any other cells in the same stack), can increase in order to compensate for the loss in operating voltage from cells 1-6. This increase in cell voltage is not the same as the recovery time during normal shunting, because most or all the cells are always under load during in-line shunting. During in-line shunting even though the current being produced when the cell voltage increases is considerably less, nevertheless, the shunted cell still has some current flowing through it. More specifically, there can be two current components going through the shunted sub-set of the fuel cell stack. One is the “load current” which also flows through the rest of the stack. The other is the “shunt current” which circulates through the shunted cells and the FET switch associated with the shunted sub-set of the fuel cell stack. Consequently, during the in-line shunt, the shunted sub-set of the fuel cell stack can be carrying a large amount of total current even though the load current component is significantly reduced due to the “increased voltage” response of all the other cells in the stack. In contrast, during recovery time for normal shunting, the group of cells being shunted is offline and no current is flowing through those cells, until they are brought back online (see designator 712).

Notice that during the normal shunting of graph 702, all the cells behave like the cells shown on graph 602 of FIG. 6, but during in-line shunting of graph 704, since only a sub-set of the stack is being shunted, the cells within the stack that do not get shunted behave differently.

Before the present in-line shunting discoveries, the existing thought was that, without any recovery time the shunted cells would not be able to recover back to the operating voltage and could potentially get reversed or damaged in some other way. But in fact the results are positively surprising in that not only did the shunted cells recover without any issues, they also produced more power than they would with normal shunting.

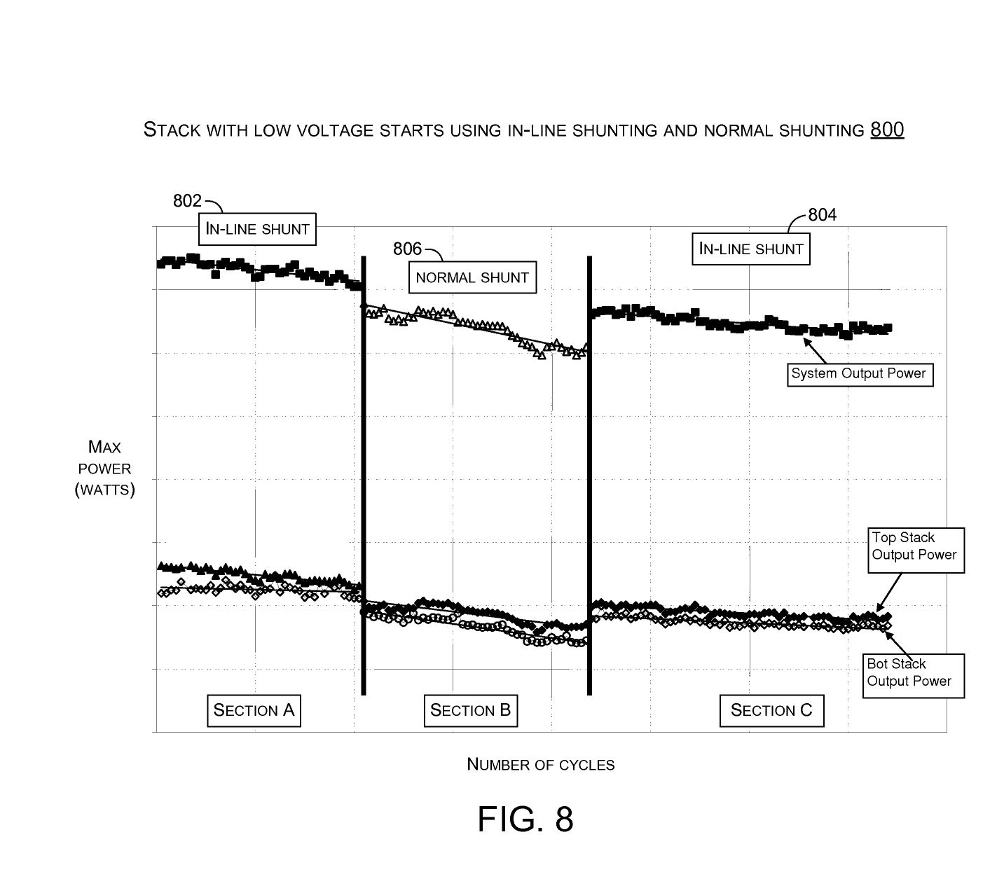

FIG. 8 shows an example comparison of shunting methods 800. The example comparison shows the performance of the above mentioned stack fuel cell system when operated with in-line shunting at 802 and 804 and normal shunting at 806.

In this example, the stack fuel cell system was operated once every 13 to 15 hours for approximately 2 hours using a low voltage start method. Each point shown in the chart is the max power during the 2 hours run for the system as well as the individual top and bottom stacks. During Sections A and C the system was operated with In-line shunting and during Section B it was operated with normal shunting.

For instance, one example stack fuel cell system includes two different 24 cell stacks, A and B. During normal shunting, Stack A was taken offline to be shunted while Stack B carried the entire load. During in-line shunting, only a sub-set of Stack A, comprising 2 to 6 cells, was shunted, without taking Stack A offline. With in-line shunting, Stack A and Stack B were both online when the shunt was performed, including the sub-set of the fuel cell stack that was being shunted. After the first sub-set of the fuel cell stack was shunted, the entire stack was allowed to recover under load for a predetermined period of time and then the second sub-set of the fuel cell stack was shunted.

Therefore, in a stack fuel cell system with two 24 cell stacks, and each sub-set comprising six cells, the stacks can be divided into eight sub-sets. Instead of shunting the entire stack during normal shunting, with in-line shunting each sub-set gets shunted without taking the stacks offline. The individual cells behave very differently with these two shunt methods;

As seen in FIG. 8, the maximum output power of the stack fuel cell system was higher with in-line shunting compared to normal shunting, and the rate of decline was also considerably less with in-line shunting. This was another unexpected result with in-line shunting. Many stack fuel cell systems have an inherent rate of decline which changes based on several parameters, one of those parameters being the effectiveness of the shunt method. Clearly, the in-line shunt method is better at reducing this rate of decline.

### Example Stack Fuel Cell System Shunting Order

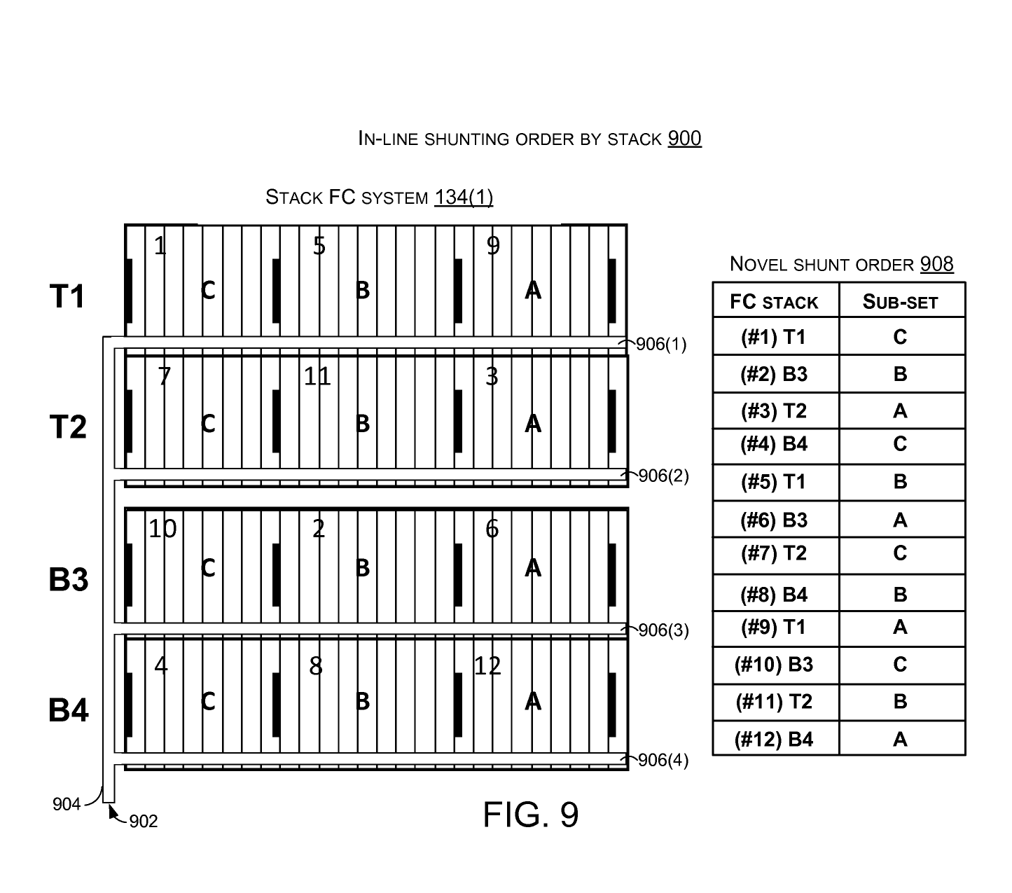

FIG. 9 relates to in-line shunting order by stack 900. FIG. 9 also shows another stack fuel cell system 134(1) in which inventive in-line shunting techniques can be employed. In this case, the stack fuel cell system 134(1) is made up of four fuel cell stacks. Each stack includes a number of cells that are compressed together. In this case, 25 cells are compressed together in each fuel cell stack. The fuel cell stacks are operated as a top pair T1 and T2 and a bottom pair B3 and B4. Further, the cells of each fuel cell stack are organized into three sub-sets A, B, and C. Of course, other numbers of stacks and/or other numbers of sub-sets per stack can be utilized in other implementations.

In this case, stack fuel cell system 134(1) also includes a fuel distribution system 902. In this example, the fuel distribution system includes a fuel distribution line 904 and fuel supply manifolds. The fuel distribution line 904 is configured to supply fuel to fuel supply manifolds that feed individual fuel cell stacks. For instance, in the illustrated configuration, the fuel supply manifolds are manifest as integral internal fuel supply manifolds 906 (e.g., built into the stack). In this example, each fuel cell stack T1, T2, B3, and B4 includes an integral internal fuel supply manifold 906 that is internal and integral to the respective stack. For example, fuel cell stack T1 includes integral internal fuel supply manifold 906(1), fuel cell stack T2 includes integral internal fuel supply manifold 906(2), fuel cell stack B3 includes integral internal fuel supply manifold 906(3), and fuel cell stack B4 includes integral internal fuel supply manifold 906(4).

The following discussion explains novel techniques of in-line shunting order to reduce (and potentially minimize) on-line recovery effects relative to stack fuel cell system 134(1). The novel in-line shunting techniques can shunt sub-sets of the fuel cell stack while in operation. The techniques can also shunt in such a pattern as to allow for increased (and potentially maximized) time in between shunts of the individual sub-sets of the fuel cell stack before returning back to the same sub-set.

During fuel cell stack operation at maximum power the cells may be designed to be approaching mass transport limitation. When a shunt occurs, the cell voltage collapses. This collapse may be caused by consumption of the available reactant gases. This shunting event can deplete the reactant gases (such as hydrogen) available to this section (e.g., sub-set) of cells and it takes some finite time period for the gas to flow back into this region. When the gas pressure is back up, the cells return to a state similar to before the shunt occurred. This duration is called recovery time.

When cells in the same fuel cell stack (T1: A, B, C) are shunted sequentially the recovery time can be longer than ideal. This may be because if two adjacent sub-sets are sequentially shunted, the gas pressure can be reduced regionally. Because of this phenomenon inventive shunt techniques are described here that can dramatically reduce the recovery effect of adjacent shunting. A description of one such shunt technique is now described relative to FIG. 9 via novel shunt order 908.

Fuel cell stack Section or Sub-set A is connected to the positive terminal and Sub-set C is connected to ground. Sub-set B is the 9 cell section while Sections A and C are the 8 cell sections. In this example of novel shunt order 908, the shunt order progresses in sequential order through the listed rows from top to bottom. For example, the novel shunt order starts by shunting Sub-set C of fuel cell stack T1, followed by Sub-set B of fuel cell stack B3 and then Sub-set A of fuel cell stack T2, etc. The shunting order is also shown on each sub-set of the stack fuel cell system 134(1). The novel shunt order reduces (and potentially avoids) detrimental fuel supply and/or oxygen supply deficiency to a recently shunted sub-set of the fuel cell stack by not selecting another sub-set for shunting that shares the same fuel supply manifold. Stated another way, the shunting order can select sub-sets for shunting that are distant from one another (e.g., from a fuel supply perspective, a fuel/oxygen perspective, and/or a physical distance perspective). Of course, there are other novel shunting orders that satisfy these criteria beyond the illustrated shunting order.

The illustrated implementation offers an example of a shunt order where sequentially shunted sub-sets of cells are not connected to the same integral internal fuel supply manifold. For instance, the first shunted sub-set C is from the first stack T1 and the second shunted sub-set B is from the third stack B3 and the third shunted sub-set A is from the second stack T2, and so forth. In this implementation each fuel cell stack has its own fuel supply manifold. As such, selecting sequential sub-sets from different fuel cell stacks can reduce or eliminate gas flow limitations through an individual fuel supply manifold. In instances where multiple fuel cell stacks share a fuel supply manifold, the shunting order can be selected to avoid subsequent shunts that might tax individual regions of the fuel supply manifold.

Stated another way, the shunting order can be selected to reduce mass transportation effects associated with supplying adequate reactant gases, such as fuel and/or oxygen, to involved cells during and after the shunt. Thus, a second sub-set of cells can be selected that is less likely to exacerbate mass transit issues related to the first sub-set.

### Example Method

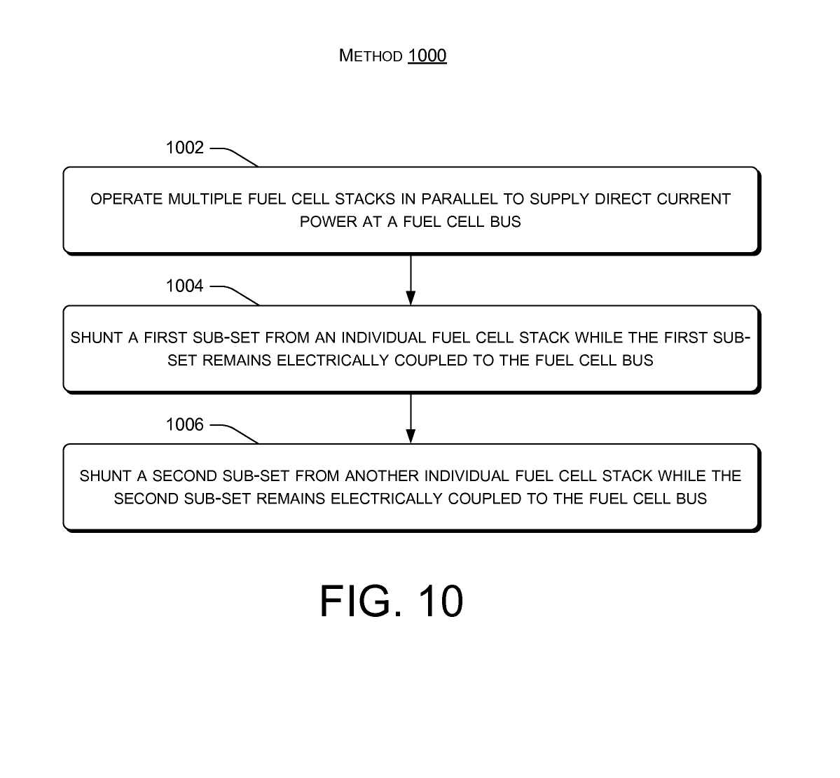

FIG. 10 is a flow chart of another technique or method for implementing in-line fuel cell stack shunting.

The method can operate multiple fuel cell stacks in parallel to supply direct current power at a fuel cell bus as indicated at 1002.

The method can shunt a first sub-set from an individual fuel cell stack while the first sub-set remains electrically coupled to the fuel cell bus as indicated at 1004.

The method can shunt a second sub-set from another individual fuel cell stack while the second sub-set remains electrically coupled to the fuel cell bus 1006. The first sub-set and the second sub-set can be relatively distant from one another from a fuel supply perspective. The shunting order can promote supplying adequate reactants (e.g., fuel and/or oxygen) to the shunted fuel cells to promote fuel cell function.

The order in which the example methods are described is not intended to be construed as a limitation, and any number of the described blocks or acts can be combined in any order to implement the methods, or alternate methods. Furthermore, the methods can be implemented in any suitable hardware, software, firmware, or combination thereof, such that a computing device can implement the method. In one case, the method is stored on one or more computer-readable storage media as a set of computer-readable instructions such that execution by a computing device (such as by a processing device) causes the computing device to perform the method. In some implementations, the in-line shunt controller and/or the DC converter can be manifest as computing devices that perform the method. A computing device can be defined as any device that has some processing and/or media storage capabilities. For instance, a computing device can be manifest as an application-specific integrated circuit (ASIC), a system-on-a-chip, or a personal computer, among others.

### CONCLUSION

Although techniques, methods, devices, systems, etc., pertaining to fuel cell stacks are described in language specific to structural features and/or methodological acts, it is to be understood that the subject matter defined in the appended claims is not necessarily limited to the specific features or acts described. Rather, the specific features and acts are disclosed as exemplary forms of implementing the claimed methods, devices, systems, etc.

1. A system, comprising:
a first set of serially electrically coupled cells compressed together to operate as a first fuel cell stack, the first set of cells sharing an integral internal fuel supply manifold;
a second set of serially electrically coupled cells compressed together to operate as a second fuel cell stack, the second set of cells sharing another integral internal fuel supply manifold, wherein the first and second fuel cell stacks are electrically coupled in parallel to one another relative to a fuel cell bus; and,
a controller configured via multiple switches to shunt a sub-set of either of the first and second fuel cell stacks while the sub-set remains electrically connected to the fuel cell bus.

2. The system of claim 1, wherein the controller is further configured to subsequently shunt another sub-set that is physically distant from the sub-set.

3. The system of claim 2, wherein the sub-set is in the first fuel cell stack and the another sub-set is in the second fuel cell stack.

4. The system of claim 2, further comprising a third set of serially electrically coupled cells compressed together to operate as a third fuel cell stack, and wherein the another sub-set is selected from the third fuel cell stack.

5. The system of claim 1, wherein the controller is further configured to maintain an output voltage at the fuel cell bus utilizing the other of the first and second fuel cell stacks.

6. A system, comprising:
a first fuel cell stack comprising multiple serially arranged cells and an integral internal fuel supply manifold configured to supply fuel to the multiple serially arranged cells;
a second fuel cell stack comprising multiple different serially arranged cells and a second integral internal fuel supply manifold configured to supply fuel to the multiple different serially arranged cells, the second fuel cell stack electrically coupled in parallel with the first fuel cell stack;
a fuel distribution system configured to distribute fuel from a fuel source to individual cells via the integral internal fuel supply manifold and the second integral internal fuel supply manifold; and,
a controller configured to shunt a first sub-set of cells from either of the first and second fuel cell stacks and then to shunt a second sub-set of cells from the other of the first and second fuel cell stacks and wherein the first sub-set of cells and the second sub-set of cells are not connected to the same integral internal fuel supply manifold.

7. The system of claim 6, wherein the controller via multiple switches is configured to perform the shunt during operation of the first and second fuel cell stacks and wherein the controller is configured to maintain electrical connectivity between the first sub-set of cells, the second sub-set of cells, and a remainder of the cells during the shunt.

8. A system, comprising:
a fuel cell stack comprising multiple serially arranged cells that are compressed against one another and are supplied by a fuel supply manifold that is integral to the fuel cell stack;
a power source electrically coupled with the fuel cell stack at a bus; and,
a controller configured to shunt sub-sets of the fuel cell stack while the fuel cell stack continues to supply power to the bus.

9. The system of claim 8, wherein the power source comprises another fuel cell stack or wherein the power source comprises a DC converter or wherein the power source comprises another fuel cell stack and a DC converter.

10. The system of claim 8, wherein the controller is further configured to shunt a first individual sub-set of the stack and then a second individual sub-set of the stack and wherein the first and second individual sub-sets are physically separated by other cells which are not in either of the first or second individual sub-sets.

11. The system of claim 10, wherein the first and second individual sub-sets of the fuel cell stack are selected to reduce mass transportation effects associated with supplying adequate fuel to involved cells during and after the shunt, or wherein the first and second individual sub-sets are selected to reduce mass transportation effects associated with supplying adequate oxygen to involved cells during and after the shunt, or wherein the first and second individual sub-sets are selected to reduce mass transportation effects associated with supplying adequate fuel and oxygen to involved cells during and after the shunt.

12. The system of claim 10, wherein the first and second individual sub-sets of the fuel cell stack are selected to reduce mass transportation effects associated with supplying adequate reactant gases to involved cells during and after the shunt.

13. The system of claim 8, further comprising a DC converter connected between the fuel cell stack and the power source and configured to leverage the power source to maintain voltage or current characteristics of power at the bus during the shunt.

14. A system, comprising:
a fuel cell stack comprising multiple serially arranged cells that are compressed against one another and are supplied by a fuel supply manifold that is integral and internal relative to the fuel cell stack; and,
an in-line shunt controller configured to sequentially shunt sub-sets of the fuel cell stack while the fuel cell stack continues to supply output power, and wherein an individual sub-set of the fuel cell stack and a next individual sub-set of the fuel cell stack are not adjacent to one another in the fuel cell stack.

15. A method, comprising:
operating multiple fuel cell stacks in parallel to supply direct current power at a fuel cell bus;
shunting a first sub-set from an individual fuel cell stack while the first sub-set remains electrically coupled to the fuel cell bus; and,
shunting a second sub-set from another individual fuel cell stack while the second sub-set remains electrically coupled to the fuel cell bus, wherein the first sub-set and the second sub-set are relatively distant from one another from a fuel supply perspective.

16. The method of claim 15, wherein the first shunted sub-set and the second shunted sub-set are on different fuel cell stacks.

17. At least one computer-readable storage media having instructions stored thereon for accomplishing the method of claim 15.

18. A system comprising a processing device and at least one computer-readable storage media having computer-readable instructions stored thereon that when executed by the processing device cause the system to perform the method of claim 15.
